(19) United States
(12) Patent Application Publication
(10) Pub. No.: US 2003/0096545 A1
(43) Pub. Date: May 22, 2003

(54) Antimicrobial, sporicidal composition and treated products thereof

(76) Inventor: Stephen A. Payne, Charlotte, NC (US)

Correspondence Address: DOUGHERTY, CLEMENTS & HOFER, 1901 ROXBOROUGH ROAD, SUITE300, CHARLOTTE, NC, 28211, US

(21) Appl. No.: 10/299,413

(22) Filed: Nov. 19, 2002

Related U.S. Application Data
(60) Provisional application No. 60/331,922, filed on Nov. 21, 2001.

(51) Int. Cl. B32B 27/04; B32B 5/02; B32B 27/12

(52) U.S. Cl. 442/123; 424/405; 424/412; 424/414; 424/443; 424/489; 427/180

(57) ABSTRACT

The present invention concerns an antimicrobial, sporicidal composition, method of making the composition, products made incorporating the composition, and methods of making products incorporating the composition. The composition comprises pyrithione and at least 100 ppm iodine-containing antimicrobial. The pyrithione can be selected from the group consisting of: sodium pyrithione, zinc pyrithione, copper pyrithione, and silver pyrithione. The iodine-containing antimicrobial is diiodomethyl-4-tolylsulfone. The ratio of parts diiodomethyl-4-tolylsulfone to parts pyrithione ranges from 1 to 1, to 1 to 7.

### CROSS REFERENCE TO RELATED APPLICATION

This application claims the benefit of U.S. Provisional Application No. 60/331,922, filed Nov. 21, 2001.

### BACKGROUND OF THE INVENTION

(1) Field of the Invention

The present invention relates to an antimicrobial, sporicidal composition especially useful in the treatment of bacterial and fungal spores. In particular, when the present composition is in contact with bacteria, fungi, yeast, and the like, its efficacy as an antimicrobial agent is excellent. More particularly, the composition of the present invention is especially surprising in that spores that remain in contact with the composition for a period of approximately 4 hours (at a 99% efficacy rate) become non-germinating. This makes the composition of the present invention especially useful for treating spores from such bacteria as anthrax. Solid materials treated with the composition are efficacious in killing and inhibiting the germination of such spores, and this is totally unexpected. Additionally, the present invention also relates to a method of making the composition, products made incorporating the composition, and methods of making products incorporating the composition.

(2) Prior Art

Antimicrobial agents are well known to those skilled in the art. Antimicrobial agents are generally compositions that are antibacterial, anti-fungal, or anti-yeast; that is, the growth of microorganisms is inhibited or the microorganisms are killed.

Antimicrobial agents are applied to many different surfaces by two different mechanisms. The first mechanism is merely the topical treatment of a surface. For example, an operating table may be wiped with an antimicrobial agent to kill or substantially reduce the bacteria, fungus, mold, or yeast. Such compositions with antimicrobials are generally referred to as disinfectants.

Another approach is to incorporate one or more types of antimicrobial agents into the composition of the material employed in making surfaces. For example, if the surface is made of plastic, the antimicrobial material may be incorporated into the plastic. This second mechanism is more efficient and longer lasting because the antimicrobial agent diffuses or migrates to the surface through the plastic such that the surface is continuously antimicrobial for years. This makes such surfaces as kitchen countertops, operating tables, hospital equipment, etc. especially attractive since the antimicrobial agent is continuously working to rid the surfaces of microbial agents. Antimicrobial agents can also be coated onto or absorbed into such applications as filter media, paint, leather (shoes), paper (envelopes and writing paper), textile applications, and bristle fibers (toothbrushes, hairbrushes, etc.).

Typical antimicrobial agents are triclosan (2,4,4′,-trichloro-2′hydroxy diphenyl ether), zinc pyrithione, 2-phenylphenol, and quaternary ammonium products, all of which are well known in the art.

Spores are reproductive cells of fungi and some bacteria. Spores usually possess a thick cell wall enabling the cell to survive adverse conditions or environments. Common fungal spores are Aspergillus, Penicillium, Cladosporium, and Alternaria. Known bacteria spores are Bacillus anthracis (commonly known as Anthrax), and Clostridium difficile, among others.

Sporicidal agents either kill spores or render them unable to regenerate or reproduce. Known sporicidals are chlorine dioxide, peracetic acid, gluteraldehydes, and hydrogen peroxide. Alcohols and bleach are known to kill spores as well. Such agents must usually be in close contact with the spores at high concentrations to be effective, and at effective concentrations such agents are toxic to humans. It would therefore be desirable to have a sporicidal composition that is less toxic at effective concentrations.

Contamination by spores represents a particular problem in that buildings must be “fumigated” with liquid or gaseous sporicidal agents in order to ensure full eradication. Experience has been that even fumigation is not always effective. The problem is that spores may infiltrate throughout the building and its infrastructure. It would therefore be desirable to be able to treat components of the building and furnishings to impart a sporicidal property as a prophylactic against contamination. It would also be desirable to treat paper and especially envelope stock such that it is sporicidal. It would also be desirable to incorporate into air filters for homes, offices, cars or trucks, a sporicidal that eradicates spores and other microbials.

### SUMMARY OF THE INVENTION

The present invention is both an antimicrobial composition as well as sporicidal, and is effective when used to pretreat surfaces. Not only is it effective against inhibiting the growth of microbes such as mold and bacteria, but also it is a sporicidal in the sense that spores contacting the composition or treated substrates are killed and germination is inhibited. As stated previously, spores are reproductive cells and rendering them incapable of reproducing in effect kills them.

In order for the composition to be sporicidally effective, the spores must remain in contact with it for at least 2 hours to be 90% effective and at least 4 hours to be 99% effective (99% of the spores are killed or are unable to germinate) at room temperature.

The composition of the present invention contains at least 2 components, namely an iodine containing compound and pyrithione, ranging from equal parts of each, to 1 part iodine containing compound with up to seven parts pyrithione. Pyrithione may be in the form of sodium pyrithione, zinc pyrithione, copper pyrithione, or silver pyrithione. Pyrithione is a derivative of pyridinethione, namely 1-hydroxy-2-pyridinethione. The iodine-containing compound can be diidomethyl-4-tolylsulfone or iodopropynyl butyl carbamate.

In the broadest sense, the present invention comprises an antimicrobial, sporicidal composition comprising an effective amount of a uniform blend of pyrithione and an iodine-containing compound. More specifically it is a blend of zinc pyrithione and diiodomethyl-4-tolylsulfone.

In the broadest sense, the present invention also comprises a method of making an antimicrobial, sporicidal composition, comprising blending one part of an iodine-containing compound with from one to seven parts by weight pyrithione. More specifically, the method comprises blending one part of diiodomethyl-4-tolylsulfone with from one to seven parts by weight zinc pyrithione.

The invention also comprises a treated product or substrate, treated with the sporicidal composition described above, such that it provides efficacy against bacterial and fungal spores. The invention also comprises the process of treating such substrates or products. Examples of such products are air filters, carpet, fabrics, wood furnishing, and duct work.

### DESCRIPTION OF THE PREFERRED EMBODIMENTS

The composition of the present invention comprises at least 100 ppm (parts per million) diiodomethyl-4-tolylsulfone and pyrithione. The pyrithione is also present at a minimum of 100 ppm. Pyrithione may be in the form of sodium pyrithione, zinc pyrithione, copper pyrithione, or silver pyrithione, or a mixture thereof and can be purchased from Arch Chemical Co. Pyrithione is a derivative of pyridinethione, namely 1-hydroxy-2-pyridinethione. Zinc pyrithione is 2-pyridinethiol-1-oxide, zinc complex. Copper pyrithione and silver pyrithione are a complex like zinc pyrithione, except that copper or silver replaces the zinc. Preferred is zinc pyrithione.

While the components can be mixed together as solids, it is preferred to create a uniform dispersion. In particular, diiodomethyl-4-tolylsulfone is employed as a dispersion where about 20-60% by weight of the dispersion is diiodomethyl-4-tolylsulfone, with the remainder being from about 1-3% by weight surfactant, 2-8% by weight of a nonionic emulsifier etc Preferred is a 40% by weight dispersion of diiodomethyl-4-tolylsulfone. Such a product is available from Dow and is sold under the trade name of Amical Flowable.

Likewise, pyrithione is employed as a dispersion where about 20-60% by weight of the dispersion is pyrithione, with the remainder being from about 1-3% by weight surfactant, 2-8% by weight of a nonionic emulsifier. Preferred is a 40% by weight dispersion of zinc omadine. Such a dispersion is sold by Arch Chemical as Zinc Omadine® ZOE dispersion.

To manufacture the composition of the present invention, uniformly mix the diiodomethyl-4-tolylsulfone dispersion with the dispersion of zinc pyrithione, at room temperature and atmospheric pressure. The dispersions were mixed in a range from about 1 part diiodomethyl-4-tolylsulfone to 1 part zinc pyrithione to a ratio of 1 part diiodomethyl-4-tolylsulfone to 7 parts zinc pyrithione. Making a dispersion of diiodomethyl-4-tolylsulfone or a dispersion of zinc pyrithione is well known to those skilled in the art and employs conventional materials such as surfactants/thickeners and conventional equipment such as heaters & mixers to create a homogeneous dispersion. The composition could be used either as is, or more commonly it would be diluted in water or other suitable medium such that the concentration of the pyrithione would be greater than or equal to 100 ppm, and the concentration of the diiodomethyl-4-tolylsulfone would be greater than or equal to 100 ppm.

The dispersion of zinc pyrithione is approximately 38% by weight zinc pyrithione while the dispersion of the diiodomethyl-4-tolylsulfone comprises about 40% by weight of the diiodomethyl-4-tolylsulfone.

The composition of the present invention is particularly useful when employed in a filter such that air borne spores and other microbials can be captured and retained against the filter mat. Filters useful in cars, trucks, airplanes, office HVAC units, etc. can filter the spores and retain them against the filter mat, where the composition of the present invention kills the mold and bacteria, and renders the spores incapable of germinating.

A filter web can be made in the conventional manner of fabric comprising either woven or nonwoven fibers. The fibers may be natural or synthetic fibers, or a mixture of these. Natural fibers useful as filter media are cotton, hemp, wool, animal hair, kenaf or a mixture thereof. Acceptable synthetic fibers are nylon, polyester, rayon, acrylic, polyolefin fibers, or a mixture thereof. The preferred fibers are formed into a nonwoven batt by conventional dry laid processes. The nonwoven filter web must be bonded by mechanical, chemical or thermal processes to create a unitary structure. Mechanical bonding uses entanglements introduced by needle punching or hydroentangling. Chemical bonding uses adhesives such as latex resins, or hot melt adhesives. Thermal bonding utilizes low melt point fibers melted in an oven (hot air, radiant or microwave), on heated calender roll(s), or by ultrasonic energy.

The preferred binder systems of the present invention are conventional latex systems, hot melt adhesives, or thermal bonding fibers, or a mixture of these. Conventional latex systems such as styrene-butadiene copolymer, acrylic/acrylate, vinyl-acetate-ethylenes, and polyvinyl acetate systems, as well as mixtures of these are well known. When a conventional latex system is employed with the present invention, the amount of binder may range from 3-50% by weight of the web. Latex systems are usually sprayed on the fibers and heated to drive off the excess liquid carrier. Hot melt adhesives are generally solid powder materials, non-latex paste, and/or liquid compositions well known to those in the art. When heated, the solid powder melts, coats at least a portion of the fibers, and is cooled to solidify. Thermal bonding comprises conventional low melt fibers, bicomponent fibers, or a mixture of these, which are melted as stated previously, and cooled to solidify the melt, thus bonding the blend of fibers. Conventional low melt fibers can be polyolefins, for example, and in particular linear low-density polyethylene.

The composition of the present invention may, for example, be incorporated into the binder system for making the filter media. If mechanical bonding is employed for a woven or nonwoven fabric, then the dispersion described above is sprayed on the filter media and dried. For nonwoven filter media that is chemically or thermally bonded the composition may comprise part of the latex or hot melt adhesive. For the hot melt adhesive or low melt polymer bonding, the composition may be used in solid form, or more typically incorporated via a low melting polymer carrier. Lastly, the sporicidal composition can be incorporated into the plastic fibers that make the web of the filter. Such plastic fibers may be polyester, polyamide, or polyolefin based, for example.

The composition may also be incorporated into paper during the paper making process, added to the last paper slurry before the paper is cast, or coated on the paper in the form of a latex, or with an aqueous or solvent based carrier, for example.

Because the sporicidal composition is particularly compatible with latices, it can be incorporated into a great many products, like paint, nonwoven textile fabrics, hospital gloves, gowns and surgical drapes, and pads for absorbing bodily fluids, like incontinent pads, or surgical pads.

### EXAMPLE 1

A standard treated HEPA filter was created. The treated HEPA filter employed a latex binder to bind the fibers or filaments employed in the HEPA filter into a unitary mass. The treated HEPA filter employed latex that contained 1100 parts per million diiodomethyl-4-tolylsulfone and 1,455 parts per million zinc pyrithione. The latex binder was added to the fiberglass mat at a level of 110% of the total weight of the fibers. The resulting concentration of the antimicrobials, based on the total weight of the filter media, was 1200 ppm diiodomethyl-4-tolylsulfone and 1600 ppm zinc pyrithione. The antimicrobials were added in the form of aqueous dispersions to the latex binder.

The procedure used for testing the antibacterial activity of the treated product was AATCC (American Association of Textile Chemists and Colorists) Test Method 147-1993. The organisms tested were Staphylococcus aureus (ATCC #6538) and Klebsiella pneumoniae (ATCC #4352). The procedure employed to test the antifungal activity was AATCC Test Method 30-Part 3 using Aspergillus niger (ATCC #6275). In both of these tests the zone of inhibition, measured in millimeters, was measured after a predetermined period of time. In particular, bacteria or fungus at a predetermined concentration is placed in contact with the antimicrobial agent for a predetermined period of time and then the zone of inhibition is measured (the extended area about the bacteria or fungus).

For the Test Method 147, zones of inhibition were obtained of 8 mm for S. aureus and 12 mm for K. pneumoniae. In the Test Method 30, part III, the treated samples was rated 0, meaning that no growth was observed on the sample, and in fact there was a zone of inhibition of 1 mm.

### EXAMPLE 2

A standard treated HEPA filter and an untreated HEPA filter were created as in Example 1. Both the treated and untreated HEPA filters employed a latex binder to bind the fibers or filaments employed in the HEPA filter into a unitary mass. The treated HEPA filter employed latex that contained 1100 parts per million diiodomethyl-4-tolylsulfone and 1,455 parts per million zinc pyrithione. The latex binder was added to the fiberglass mat at a level of 110% of the total weight of the fibers. The resulting concentration of antimicrobials, based on the total weight of the filter media, was 1200 ppm diiodomethyl-4-tolylsulfone and 1600 ppm zinc pyrithione. The antimicrobials were added in the form of aqueous dispersions. The untreated HEPA filter controlled used the same latex binder, but without antimicrobials being added.

The samples were tested using a modified AATCC Test Method 100 test. Test samples were cut into 1″×1″ squares. The squares were inoculated with a 1.0 ml aliquot of Bacillus subtilis var niger spores (strain ATCC #9372) (varieties of Bacillus subtilis spores are recognized as surrogates for Bacillus anthracis) at a concentration of approx. 106 spores/ml in soybean casein digest broth (SCDB). The inoculum remained in contact with the filter for a fixed contact time in a sterile Petri dish, and then the samples were placed in 100 ml of letheen broth for recovery of the surviving organisms. The contact times were 0, 2, 4, 8, 24, and 48 hours, with three samples being done for each contact time, for both treated and untreated filter samples. The recovered organisms were plated onto sterile agar and cultured for approximately 24 hours to determine plate counts (colony forming units, CFU). The results are shown in Table I. In addition samples of the recovered inoculum were heat-shocked at 80-85° C. for 20 minutes to force germination of surviving spores. Results are shown in Table 2.

The treated HEPA filter inoculum showed a 90% reduction in the spores (90% were killed or were unable to germinate) after 2 hours and a 99% reduction after 4 hours. For the untreated HEPA filter, the spores showed no reduction after 2 hours and a slight increase in CFUs after 4 hours. Furthermore, after 48 hours, there was a 100-fold increase in the colony forming units on the untreated HEPA filter, demonstrating that a normal HEPA filter would actually support germination and growth of the bacterium.

TABLE 1

| | | Treated | Untreated |
|---|---|---|---|
| Time Point | | Filter Recovered CFU | Filter Recovered CFU |
| 0 | | 3.2 × 10⁶ | 2.5 × 10⁶ |
| 2 | Hours | 2.4 × 10⁵ | 2.7 × 10⁶ |
| 4 | Hours | 2.5 × 10⁴ | 2.9 × 10⁸ |
| 8 | Hours | 2.5 × 10⁴ | 5.7 × 10⁶ |
| 24 | Hours | 1.5 × 10⁴ | 1.8 × 10⁸ |
| 48 | Hours | 1.0 × 10⁴ | 3.2 × 10⁸ |

The purpose of heat shocking the recovered inoculum was to test whether or not the antimicrobials were affecting the spores, i.e. being sporicidal, or simply killing the bacteria after the spores had germinated. Heat shocking the recovered inoculum would kill living organisms while forcing germination of the spores. The fact that the pre-heat shock and post-heat shock results are nearly the same for the treated filter media demonstrates that the composition and the treated filter are sporicidal, rather than just antibacterial. The results for the untreated filter demonstrate that without the sporicidal treatment, the spores are germinating on the filter. The results for the treated sample vs. the untreated sample also demonstrate that even though the composition may not completely eradicate the viable spores in the given period of time, they are inhibiting germination of the spores, in itself a valuable property.

TABLE 2

| | | Treated | | Untreated | |
|---|---|---|---|---|---|
| | | Pre- | Post | Pre- | Post |
| Time Point | | Heat Shock | Heat-Shock | Heat Shock | Heat-Shock |
| 0 | Hrs. | 3.2 × 10⁶ | 7.9 × 10⁵ | 2.5 × 10⁶ | 7.0 × 10⁵ |
| 2 | Hrs. | 2.4 × 10⁵ | 2.0 × 10⁴ | 2.7 × 10⁶ | 2.3 × 10⁴ |
| 4 | Hrs. | 2.5 × 10⁴ | 1.5 × 10⁴ | 2.9 × 10⁶ | 1.1 × 10⁴ |
| 8 | Hrs. | 2.5 × 10⁴ | 2.5 × 10⁴ | 5.8 × 10⁵ | 1.2 × 10⁴ |
| 24 | Hrs. | 1.5 × 10⁴ | 1.5 × 10⁴ | 1.8 × 10⁸ | 5.0 × 10³ |
| 48 | Hrs. | 1.0 × 10⁴ | 1.3 × 10⁴ | 3.2 × 10⁸ | 9.0 × 10³ |

Based on Examples 1 and 2, the combination of zinc omadine and diiodosulfone shows both an antimicrobial as well as a sporicidal efficacy.

### EXAMPLE 3

Paper, suitable for use in mailing envelopes, was treated by coating with a thin layer containing the antimicrobial, sporicidal composition of the invention. The envelope stock was treated such that the 1600 parts per million of zinc pyrithione and 1200 parts per million of diiodomethyl-4-tolylsulfone were applied, based on the total weight of the paper. The envelope stock was tested as in Example 2, with the exception that the organism used was the spore form of Bacillus subtilis var globigii (ATCC #51189). The results are as shown in Table 3.

TABLE 3

| Time Point | | Treated Envelope Stock | Untreated Envelope Stock |
|---|---|---|---|
| 0 | Hrs. | 8.9 × 10⁵ | 1.0 × 10⁶ |
| 2 | Hrs. | 4.9 × 10⁴ | 8.1 × 10⁵ |
| 4 | Hrs. | 1.8 × 10⁴ | 6.4 × 10⁵ |
| 8 | Hrs. | 5.3 × 10³ | 3.9 × 10⁵ |
| 24 | Hrs. | 2.2 × 10³ | 2.3 × 10⁷ |
| 48 | Hrs. | 4.3 × 10² | 2.3 × 10⁶ |

Within two hours viable spores had been reduced by 95%, and within 24 hours the viable spore count had been reduced by 99.8% or nearly 3 log units. In contrast at 24 hours the spores had begun to germinate and the bacteria propagate on the surface of the envelope stock.

As in Example 2, recovered inoculum samples were heat-shocked to demonstrate that the effect was on the spores and not the vegetative form emerging from the spores. The results are shown in Table 4.

TABLE 4

| | | Treated Envelope Stock | | Untreated Envelope Stock | |
|---|---|---|---|---|---|
| | | Pre- | Post- | Pre- | Post- |
| Time Point | | Heat Shock | Heat Shock | Heat Shock | Heat Shock |
| 0 | Hrs. | 8.9 × 10⁵ | 3.1 × 10⁵ | 1.0 × 10⁶ | 3.3 × 10⁵ |
| 2 | Hrs. | 4.9 × 10⁴ | 1.9 × 10⁴ | 8.1 × 10⁵ | 5.1 × 10⁴ |
| 4 | Hrs. | 1.8 × 10⁴ | 4.7 × 10³ | 6.4 × 10⁵ | 5.3 × 10³ |
| 8 | Hrs. | 5.3 × 10³ | 4.0 × 10³ | 3.9 × 105 | 2.9 × 10³ |
| 24 | Hrs. | 2.2 × 10³ | 1.8 × 10³ | 2.3 × 10⁷ | 1.4 × 10³ |
| 48 | Hrs. | 4.3 × 10² | 6.0 × 10² | 2.3 × 10⁶ | 4.0 × 10² |

Thus it is apparent that there has been provided, in accordance with the invention, a product and a process for making that product that fully satisfies the objects, aims, and advantages set forth above. While the invention has been described in conjunction with the specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the present invention.

What is claimed is:

1. An antimicrobial, sporicidal composition containing pyrithione and at least 100 ppm iodine-containing antimicrobial.

2. The composition of claim 1, wherein the iodine-containing antimicrobial is diiodomethyl-4-tolylsulfone.

3. The composition of claim 2, wherein the ratio of parts diiodomethyl-4-tolylsulfone to parts pyrithione ranges from 1 to 1, to 1 to 7.

4. The composition of claim 1, wherein said pyrithione is selected from the group consisting of: sodium pyrithione, zinc pyrithione, copper pyrithione, and silver pyrithione.

5. The composition of claim 4, wherein said pyrithione is zinc pyrithione.

6. An antimicrobial, sporicidal product incorporated with the composition of claim 1.

7. The antimicrobial, sporicidal product of claim 6, wherein said product is paint.

8. The antimicrobial, sporicidal product of claim 6, wherein said product is a paper product.

9. The antimicrobial, sporicidal product of claim 8, wherein said paper is coated with said composition.

10. An antimicrobial, sporicidal envelope made with the paper of claim 9.

11. The antimicrobial, sporicidal product of claim 6, wherein said product is a filter.

12. The antimicrobial, sporicidal product of claim 11, wherein said filter contains natural or synthetic, or organic, or inorganic fibers or a combination thereof.

13. The antimicrobial, sporicidal product of claim 11, wherein said filter contains a chemical binder or a thermal binder.

14. The antimicrobial, sporicidal product of claim 13, wherein said antimicrobial, sporicidal composition is incorporated into said binder.

15. The antimicrobial, sporicidal product of claim 14, wherein said composition is added as a solid.

16. The antimicrobial, sporicidal product of claim 11, wherein said composition is added to said filter as a dispersion.

17. The antimicrobial, sporicidal product of claim 11, wherein said iodine-containing antimicrobial is diiodomethyl-4-tolylsulfone.

18. The antimicrobial, sporicidal product of claim 17, wherein the ratio of parts diiodomethyl-4-tolylsulfone to parts pyrithione ranges from 1 to 1, to 1 to 7.

19. The antimicrobial, sporicidal product of claim 11, wherein said pyrithione is selected from the group consisting of: sodium pyrithione, zinc pyrithione, copper pyrithione, and silver pyrithione.

20. The antimicrobial, sporicidal product of claim 19, wherein said pyrithione is zinc pyrithione.

21. The process of making an antimicrobial, sporicidal composition, comprising mixing pyrithione and at least 100 ppm diiodomethyl-4-tolylsulfone wherein the ratio of parts diiodomethyl-4-tolylsulfone to parts pyrithione ranges from 1 to 1, to 1 to 7.

22. The process of claim 21, wherein said pyrithione is selected from the group consisting of: sodium pyrithione, zinc pyrithione, copper pyrithione, and silver pyrithione.

23. The process of claim 22, wherein said pyrithione is zinc pyrithione.

24. A process for making a sporicidal filter, comprising: providing a plurality of dry laid fibers, binding said fibers into a unitary structure, and coating said fibers with an antimicrobial, sporicidal composition comprising pyrithione and at least 100 ppm iodine-containing antimicrobial.

25. The process of claim 24, wherein said fibers are natural, synthetic, or a combination thereof.

26. The process of claim 24, wherein said binding step employs a chemical binder or a thermal binder.

27. The process of claim 26, wherein said antimicrobial, sporicidal composition is incorporated into said binder and said binder is coated on said fibers.

28. The process of claim 27, wherein said composition is added as a solid.

29. The process of claim 24, wherein said fibers are mechanically bonded and said composition is added to said fibers as a dispersion.

30. The process of claim 24, wherein said iodine-containing antimicrobial is diiodomethyl-4-tolylsulfone.

31. The process of claim 30, wherein the ratio of parts diiodomethyl-4-tolylsulfone to parts pyrithione ranges from 1 to 1, to 1 to 7.

32. The process of claim 24, wherein said pyrithione is selected from the group consisting of: sodium pyrithione, zinc pyrithione, copper pyrithione, and silver pyrithione.

33. The process of claim 32, wherein said pyrithione is zinc pyrithione.

34. The antimicrobial, sporicidal product of claim 6, wherein said product is a latex binding agent.

35. An antimicrobial, sporicidal carpet incorporating the antimicrobial, sporicidal latex binding agent of claim 34.

36. The antimicrobial, sporicidal product of claim 34, wherein said latex is selected from the group containing acrylic latex, polyvinyl acetate latex, vinyl acetate-ethylene latex, and styrene-butadiene latex.

37. A non-woven fabric comprising:
a) a web of textile fibers; and
b) a polymeric binding agent selected from the group containing acrylics, polyvinyl acetates, vinyl acetate-ethylenes, and styrene-butadiene lattices;
wherein said binding agent includes an antimicrobial, sporicidal composition containing pyrithione and at least 100 ppm iodine-containing antimicrobial.

38. The non-woven fabric of claim 37, wherein said iodine-containing antimicrobial is diiodomethyl-4-tolylsulfone.

39. The non-woven fabric of claim 38, wherein the ratio of parts diiodomethyl-4-tolylsulfone to parts pyrithione ranges from 1 to 1, to 1 to 7.

40. The non-woven fabric of claim 37, wherein said pyrithione is zinc pyrithione.
